(19) United States
(12) Patent Application Publication
(10) Pub. No.: US 2014/0114620 A1
(43) Pub. Date: Apr. 24, 2014

(54) METHODS, SYSTEMS, AND MEDIA FOR INTERACTIVE GARMENT MODELING AND EDITING

(71) Applicants: Eitan Grinspun, New York, NY (US); Daniel M. Kaufman, Brooklyn, NY (US); Nobuyuki Umetani, Tokyo (JP); Takeo Igarashi, Tokyo (JP)

(72) Inventors: Eitan Grinspun, New York, NY (US); Daniel M. Kaufman, Brooklyn, NY (US); Nobuyuki Umetani, Tokyo (JP); Takeo Igarashi, Tokyo (JP)

(21) Appl. No.: 13/883,563

(22) PCT Filed: Nov. 7, 2011
(86) PCT No.: PCT/US11/59649

§ 371 Date: Dec. 20, 2013

Related U.S. Application Data
(60) Provisional application No. 61/410,913, filed on Nov. 7, 2010.
(60) Provisional application No. 61/436,570, filed on Jan. 26, 2011.

(51) Int. Cl. G06F 17/50; A41H 3/00

(52) U.S. Cl. CPC G06F 17/5009; A41H 3/007
USPC 703/1

(57) ABSTRACT

Methods, systems, and media for interactive garment modeling and editing are provided. In some embodiments, a method for designing garments is provided, the method comprising: receiving a pattern template comprising a plurality of two-dimensional pattern elements for designing a garment; simultaneously displaying the plurality of two-dimensional pattern elements and a three-dimensional draped model, wherein the three-dimensional draped model is a simulated representation of the two-dimensional pattern elements stitched together; receiving an alteration command to at least a portion of one of: a pattern element of the plurality of two-dimensional pattern elements and the three-dimensional draped model; in response to receiving the alteration command, determining sensitivity information for predicting changes to the plurality of two-dimensional pattern elements and the three-dimensional draped model; and simultaneously updating the plurality of two-dimensional pattern elements and the three-dimensional draped model based at least in part on the determined sensitivity information.

### CROSS REFERENCE TO RELATED APPLICATIONS

This application claims the benefit of U.S. Provisional Patent Application No. 61/410,913, filed Nov. 7, 2010 and U.S. Provisional Patent Application No. 61/436,570, filed Jan. 26, 2011, which are hereby incorporated by reference herein in their entireties.

### STATEMENT REGARDING FEDERALLY SPONSORED RESEARCH OR DEVELOPMENT

The invention was made with government support under CAREER Award No. CCF-0643268 and Grant No. IIS 09-16129 awarded by the National Science Foundation (NSF). The government has certain rights in the invention.

### TECHNICAL FIELD

Methods, systems, and media for interactive garment modeling and editing are provided. More particularly, an interactive garment designing application that simultaneously and synchronously models a two-dimensional garment pattern and its corresponding three-dimensional draped representation is provided.

### BACKGROUND

The garment design process generally involves multiple iterations of drafting, synthesis, and revision. Each person involved in the garment design process typically brings a specialized set of skills or knowledge. For example, a garment designer conceptualizes an initial idea for a garment in the form of sketches. The sketches can be provided to a pattern maker that drafts precise patterns or pieces of textile. The garment manufacturer can then manufacture an initial garment, where a three-dimensional form of the initial garment comes together when the flat pieces of textile are stitched together. The revision of the initial garment then iteratively continues between the garment designer, the pattern marker, and the manufacturer, where the garment alternates between tentative patterns used to form a corresponding garment and the resulting garment revealing the desired edits or alterations and induce additional alterations of the garment and the corresponding patterns. These multiple iterations consume a significant amount of raw materials, time, and energy.

In addition, it should be noted that draping a garment over a curved body, such as a dress form, is affected by frictional contact and that mapping from two-dimensional pieces of textile to a three-dimensional representation is both complex and nonlinear. Another particular challenge in sketching three-dimensional forms is to consider the wrinkles and bulges that are formed when draped over the curved body. On the other hand, revising two-dimensional pieces of textile can cause unintended side effects, such as pinching, buckling, and tight spots, which are often only discovered after time- and resource-consuming assembly.

In the graphics, film, and entertainment industries, artists are often not trained in tailoring and, because of this, clothing is designed directly by sculpting a three-dimensional model. However, such clothing often does not look realistic because it cannot be constructed from flat panels.

Recent approaches have focused on predicting the three-dimensional shape of the garment in a virtual environment using physics-based simulations and without experimenting with actual cloth. However, these simulations are slow to compute, thus making such simulations not useful for garment design.

Accordingly, methods, systems, and media are provided that overcome these and other deficiencies of the prior art.

### SUMMARY

Mechanisms for interactive garment modeling and editing are provided.

These mechanisms can simultaneously display two-dimensional flat patterns for constructing a garment and a three-dimensional draped representation of the garment, where the two-dimensional flat patterns and the three-dimensional draped representation can maintain correspondence such that the three-dimensional representation is a rendered draped form resulting from the two-dimensional flat patterns and the two-dimensional flat patterns can be used to construct the garment shown by the three-dimensional representation.

This allows users to interactively edit two-dimensional flat patterns and instantaneously obtain feedback with the resulting three-dimensional draped representation, thereby enabling rapid prototyping of a garment and providing an understanding of the complex draped representation. For example, the three-dimensional draped form can be automatically updated at interactive rates as the flat pattern is edited. The user can add new flat panels to the pattern, insert darts, pleats, stitches, holes, and cuts into the flat pattern, and can see the resulting effect on the three-dimensional draped form in real time.

With bidirectional editing, this can also allow the user to interactively mark, sculpt, refine, and/or revise a three-dimensional draped representation of a garment and be provided with the two-dimensional flat patterns for achieving or constructing the garment shown in the three-dimensional view.

It should be noted that these mechanisms can be used in a variety of applications. For example, these mechanisms can be used in the apparel industry for designing fashionable clothing that is original and comfortable with high yield rate cloth patterns. In another example, these mechanisms can be used in the animation and entertainment industries to design garments for animated characters.

In accordance with various embodiments of the disclosed subject matter, a method for designing garments is provided. The method comprises: receiving a pattern template comprising a plurality of two-dimensional pattern elements for designing a garment; simultaneously displaying the plurality of two-dimensional pattern elements and a three-dimensional draped model, wherein the three-dimensional draped model is a simulated representation of the two-dimensional pattern elements stitched together; receiving an alteration command to at least a portion of one of: a pattern element of the plurality of two-dimensional pattern elements and the three-dimensional draped model; in response to receiving the alteration command, determining sensitivity information for predicting changes to the plurality of two-dimensional pattern elements and the three-dimensional draped model; and simultaneously updating the plurality of two-dimensional pattern elements and the three-dimensional draped model based at least in part on the determined sensitivity information.

In some embodiments, a system for designing garments is provided. The system includes a processor, wherein the processor is configured to: receive a pattern template comprising a plurality of two-dimensional pattern elements for designing a garment; simultaneously display the plurality of two-dimensional pattern elements and a three-dimensional draped model, wherein the three-dimensional draped model is a simulated representation of the two-dimensional pattern elements stitched together; receive an alteration command to at least a portion of one of: a pattern element of the plurality of two-dimensional pattern elements and the three-dimensional draped model; in response to receiving the alteration command, determine sensitivity information for predicting changes to the plurality of two-dimensional pattern elements and the three-dimensional draped model; and simultaneously update the plurality of two-dimensional pattern elements and the three-dimensional draped model based at least in part on the determined sensitivity information.

In some embodiments, a non-transitory computer-readable medium containing computer-executable instructions that, when executed by a processor, cause the processor to perform a method for designing garments is provided, the method comprising: receiving a pattern template comprising a plurality of two-dimensional pattern elements for designing a garment; simultaneously displaying the plurality of two-dimensional pattern elements and a three-dimensional draped model, wherein the three-dimensional draped model is a simulated representation of the two-dimensional pattern elements stitched together; receiving an alteration command to at least a portion of one of: a pattern element of the plurality of two-dimensional pattern elements and the three-dimensional draped model; in response to receiving the alteration command, determining sensitivity information for predicting changes to the plurality of two-dimensional pattern elements and the three-dimensional draped model; and simultaneously updating the plurality of two-dimensional pattern elements and the three-dimensional draped model based at least in part on the determined sensitivity information.

### BRIEF DESCRIPTION OF THE DRAWINGS

FIG. 1 shows an illustrative example of a display screen that includes two-dimensional flat patterns and a three-dimensional draped representation in accordance with some embodiments of the disclosed subject matter.

FIG. 2 shows an illustrative example of the interactive bidirectional editing feature, where a modification to the three-dimensional draped representation is simultaneously reflected in the two-dimensional flat patterns, in accordance with some embodiments of the disclosed subject matter.

FIG. 3 shows an illustrative example of the interactive bidirectional editing feature, where a modification to a pattern of the two-dimensional flat patterns is simultaneously reflected in the three-dimensional draped representation, in accordance with some embodiments of the disclosed subject matter.

FIG. 4 shows an illustrative example of a display screen that allows the user to initiate the design process with a sloper or template and modify parameters associated with the sloper in accordance with some embodiments of the disclosed subject matter.

FIG. 5 shows an illustrative example of multiple garments that can be designed for different bodies using the same sloper in accordance with some embodiments of the disclosed subject matter.

FIG. 6 shows an illustrative example of using a dart tool for creating a dart in a two-dimensional flat pattern in accordance with some embodiments of the disclosed subject matter.

FIG. 7 shows a graphical representation of a static equilibrium equation for synchronizing the two-dimensional perspective and the three-dimensional perspective in accordance with some embodiments of the disclosed subject matter.

FIG. 8 shows an illustrative example of aggregating sensitivity information to generate a nonlinear approximation in accordance with some embodiments of the disclosed subject matter.

FIG. 9 shows an illustrative comparison of sensitivity approaches and, in particular, the result from progressive sensitivity analysis with a generalized moving least squares approach in accordance with some embodiments of the disclosed subject matter.

FIG. 10 shows an illustrative example of identifying a corresponding point on a two-dimensional pattern in response to a user selection of a particular point on a three-dimensional draped representation in accordance with some embodiments of the disclosed subject matter.

FIG. 11 shows an illustrative example of tensor fields based on particular two-dimensional pattern elements (e.g., darts) in accordance with some embodiments of the disclosed subject matter.

FIG. 12 shows an illustrative comparison of an undeformed mesh and various mesh manipulation approaches in accordance with some embodiments of the disclosed subject matter.

FIG. 13 shows an illustrative example of seams between two-dimensional flat patterns in accordance with some embodiments of the disclosed subject matter.

FIG. 14 is a diagram showing an illustrative example of a process for generating and synchronizing two-dimensional flat patterns and a three-dimensional draped representation in response to user alterations in accordance with some embodiments of the disclosed subject matter.

FIGS. 15-17 are illustrative examples of creating and editing two-dimensional flat patterns and/or a three-dimensional simulation of a garment that was initiated with a sloper and manufacturing the actual garment in accordance with some embodiments of the disclosed subject matter.

FIG. 18 is a diagram of an illustrative system on which an interactive garment designing application can be implemented in accordance with some embodiments of the disclosed subject matter.

FIG. 19 is a diagram of an illustrative user computer and server as provided, for example, in FIG. 18 in accordance with some embodiments of the disclosed subject matter.

### DETAILED DESCRIPTION

In accordance with various embodiments of the disclosed subject matter, an interactive garment designing application (sometimes referred to herein as “the application”) is provided. The interactive garment designing application can simultaneously display a two-dimensional flat pattern for constructing a garment and a three-dimensional draped representation of the garment, where the two-dimensional flat patterns and the three-dimensional draped representation can maintain correspondence such that the three-dimensional representation is a rendered draped form resulting from the two-dimensional flat patterns and the two-dimensional flat patterns can be used to construct the garment shown by the three-dimensional representation. This can allow users to interactively edit two-dimensional flat patterns and instantaneously obtain feedback with the resulting three-dimensional draped representation, thereby enabling rapid prototyping of a garment and providing an understanding of the complex draped representation. This can also allow users to interactively edit three-dimensional draped representations of a garment and be provided with the two-dimensional flat patterns for constructing a garment shown by the three-dimensional draped representation.

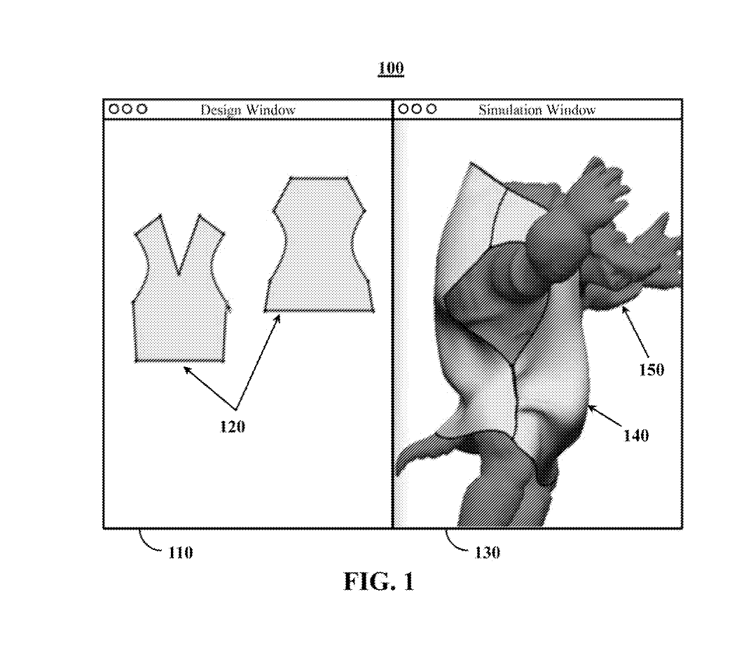

The interactive garment designing application can be used in a variety of applications. For example, the interactive garment designing application can be used in the apparel industry for designing fashionable clothing that is original and comfortable with high yield rate cloth patterns. In another example, the interactive garment designing application can be used in the computer animation industry to design clothes for animated characters (see, e.g., the armadillo model in FIG. 1). In yet another example, the interactive garment designing application can be used in the upholstering industry for designing furniture or seats for vehicles (e.g., car seats). In a further example, the interactive garment designing application can be used to design patterns for balloon or plush toys, design tension structures (e.g., large tents for pavilions), and/or metal folding processes.

Turning to FIG. 1, FIG. 1 shows an illustrative example of a display screen 100 provided by the interactive garment designing application in accordance with some embodiments of the disclosed subject matter. As shown in FIG. 1, the application can display a design window 110 that includes two-dimensional flat patterns 120 used to create a garment. As also shown in FIG. 1, the application can simultaneously display a simulation window 130 that includes a three-dimensional simulated representation 140 resulting from the two-dimensional flat patterns draped over a body 150.

It should be noted that, as shown in FIG. 1, the design window 110 and the simulation window 130 can be displayed side-by-side. However, the design window 110 and the simulation window 130 can be displayed using any suitable approach. For example, the design window 110 and the simulation window 130 can be movable windows, where the size, position, zoom level, and/or point of view can be altered. In another example, the two-dimensional flat patterns 120 shown in the design window 110 and the three-dimensional draped representation in the simulation window 130 can be shown in a single window.

In some embodiments, the application can provide the user with an interactive bidirectional editing feature that maintains correspondence between the flat patterns 120 shown in the two-dimensional view 110 and the three-dimensional draped representation 140 shown in the three-dimensional view 130. For example, in response to altering the two-dimensional flat pattern 120 (e.g., adding or modifying a dart, altering the shape or position of a pattern boundary, etc.), the application can simultaneously and/or synchronously simulate and update the corresponding three-dimensional draped representation with the alterations as the flat pattern is being altered. In another example, in response to altering the three-dimensional draped representation, the application can simultaneously and/or synchronously simulate and update the alterations to the corresponding two-dimensional flat patterns as the draped representation is being altered.

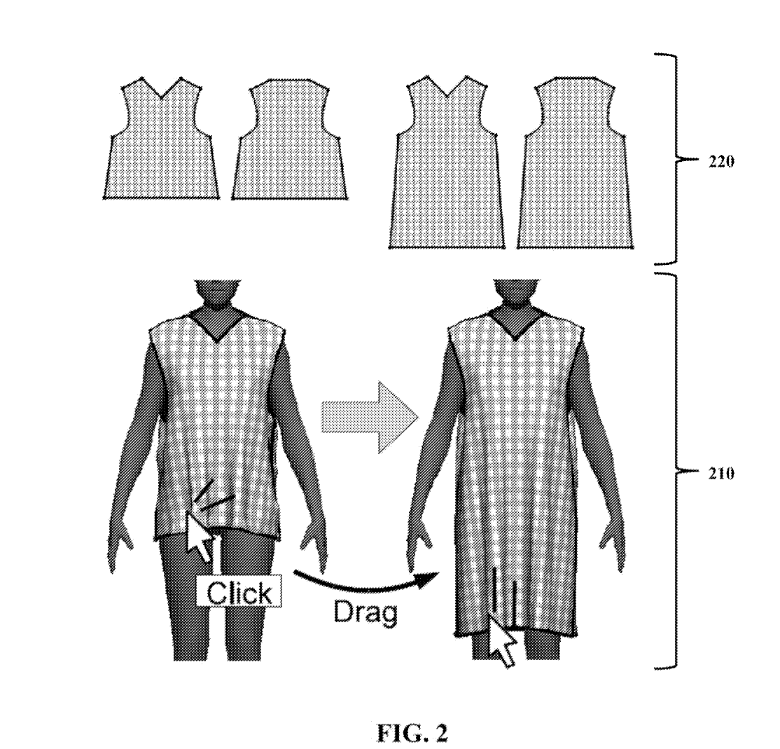

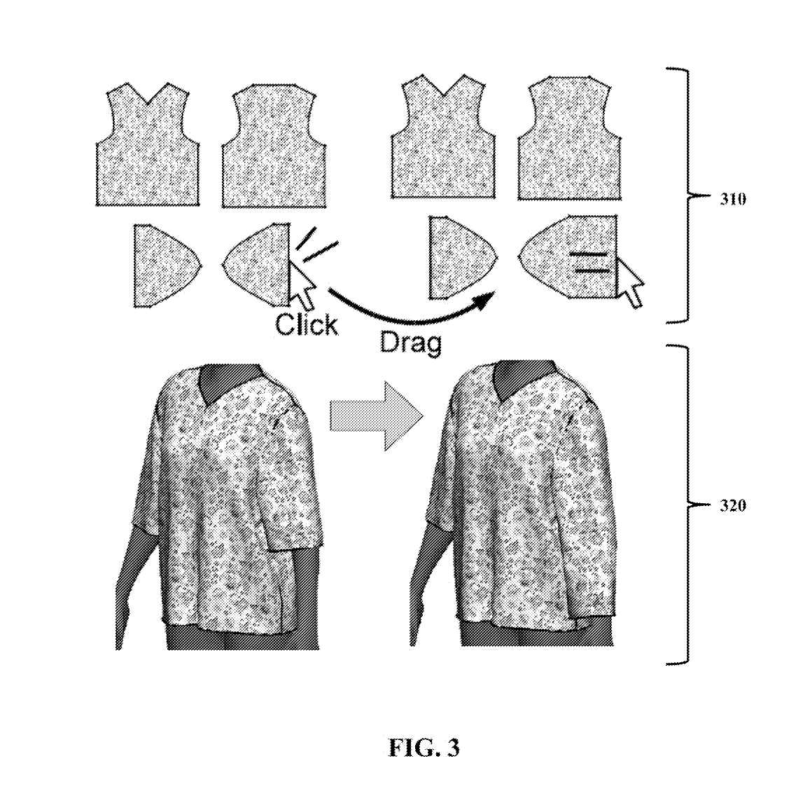

Illustrative examples of the interactive bidirectional editing feature are shown in FIGS. 2 and 3. For example, as shown in FIG. 2, in response to receiving user commands from a user input device (e.g., one or more mouse movements), the application can update the three-dimensional draped representation to reflect the alteration and can simultaneously update the corresponding two-dimensional flat patterns. More particularly, as shown in area 210 of FIG. 2, using a mouse pointer, the user selects the lower boundary of the three-dimensional draped representation and drags the mouse pointer in a downward direction to a new mouse position, thereby causing the application to lengthen the dress shown in the three-dimensional draped representation. As the three-dimensional draped representation is updated in response to the alteration in real time, the application shows the modifications to the two-dimensional flat patterns in real time. For example, as shown in area 220, the flat patterns of the garment are concurrently updated to reflect the alterations made to the three-dimensional draped representation.

Similarly, as shown in FIG. 3, in response to receiving user commands from a user input device (e.g., one or more mouse movements), the application can update the flat patterns to reflect the desired alteration and can simultaneously update the corresponding three-dimensional draped representation. More particularly, as shown in area 310 of FIG. 3, using a mouse pointer, the user selects the right boundary line of a sleeve portion of a flat pattern and drags the mouse pointer in a lateral direction to a new mouse position, thereby causing the application to lengthen the sleeve of the garment. As the two-dimensional flat pattern is updated in response to the alteration in real time, the application displays the modifications to the three-dimensional draped representation in real time. For example, as shown in area 320, the sleeve of the draped representation is concurrently updated to reflect the alterations made to the flat pattern.

It should be noted that the application can continue to calculate and display revised or altered versions of the three-dimensional draped representation and the flat patterns until, for example, the user releases the mouse button or the user breaks contact with any other suitable user input device.

It should also be noted that, although the embodiments described herein generally create and/or edit patterns and draped forms using mouse movements, any suitable user input device for performing a gesture can be used. For example, when the application is executed on a computing device with a touch screen, the user may make contact with the touch screen using any suitable object or appendage, such as a stylus, finger, etc. In another example, instead of clicking or selecting with a mouse, the application can respond to contact with a touch screen, such as one or more taps on the touch screen, maintaining continuous contact with the touch screen, movement of the point of contact while maintaining continuous contact, a breaking of the contact, or any combination thereof.

It should also be noted that the application calculates and displays revisions or alterations to the three-dimensional draped representation and the flat patterns at an interactive rate to provide real-time updates.

In some embodiments, the interactive garment designing application allows the user to create and perform various modifications to the flat patterns and/or the three-dimensional draped representation with multiple interactive tools. For example, in some embodiments, upon execution of the interactive garment designing application, the application can begin with a blank display screen that allows the user to sketch one or more flat panels in a two-dimensional garment pattern. During the sketching and creation of the flat patterns, the application simultaneously calculates and displays the three-dimensional draped form that would result from stitching together the sketched patterns.

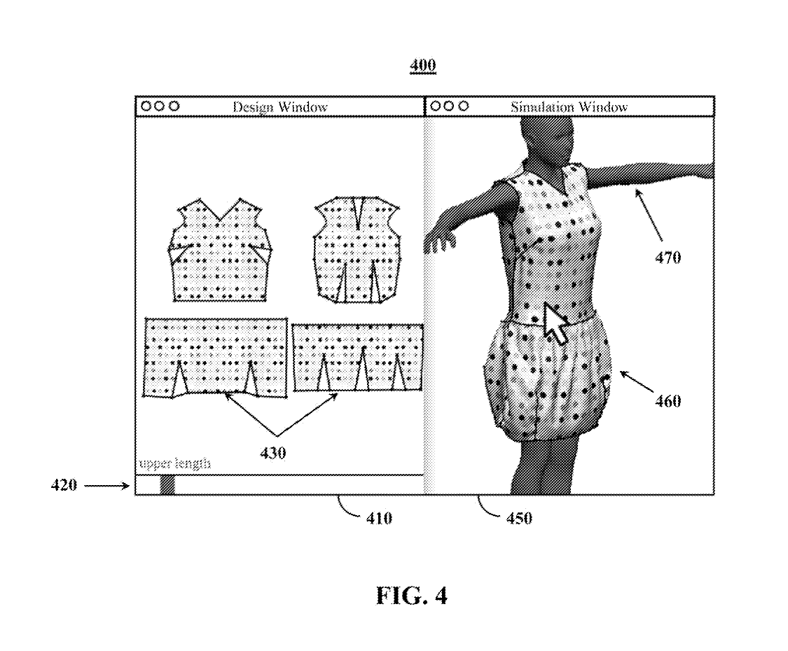

In some embodiments, the interactive garment designing application can provide the user with one or more slopers or templates for creating a garment. Generally speaking, a sloper can be one or more patterns templates drafted to particular measurements intended as a starting point for a garment. The sloper can be defined by one or more parameters, such as height, girth, sleeve length, upper length, lower length, waist width, etc. In a more particular example, FIG. 4 shows an illustrative example of a display screen 400 provided by the interactive garment designing application for modifying a parameter of a sloper in accordance with some embodiments of the disclosed subject matter. As shown in design window 410 of FIG. 4, the application can provide the user with a parameter modification option 420 for modifying a selected parameter of the sloper. More particularly, the user has selected to modify the upper waist length parameter of a given sloper and, in response to moving or sliding option 420 to the right, the application lengthens the upper waist of garment patterns 430 and, within simulation window 450, the three-dimensional draped representation 460 over body 470. In addition, the parameters of the sloper can be modified by direct manipulation of the pattern or the draped representation—e.g., in FIG. 2, the user tugs on or drags the hemline to make the skirt portion of the garment longer.

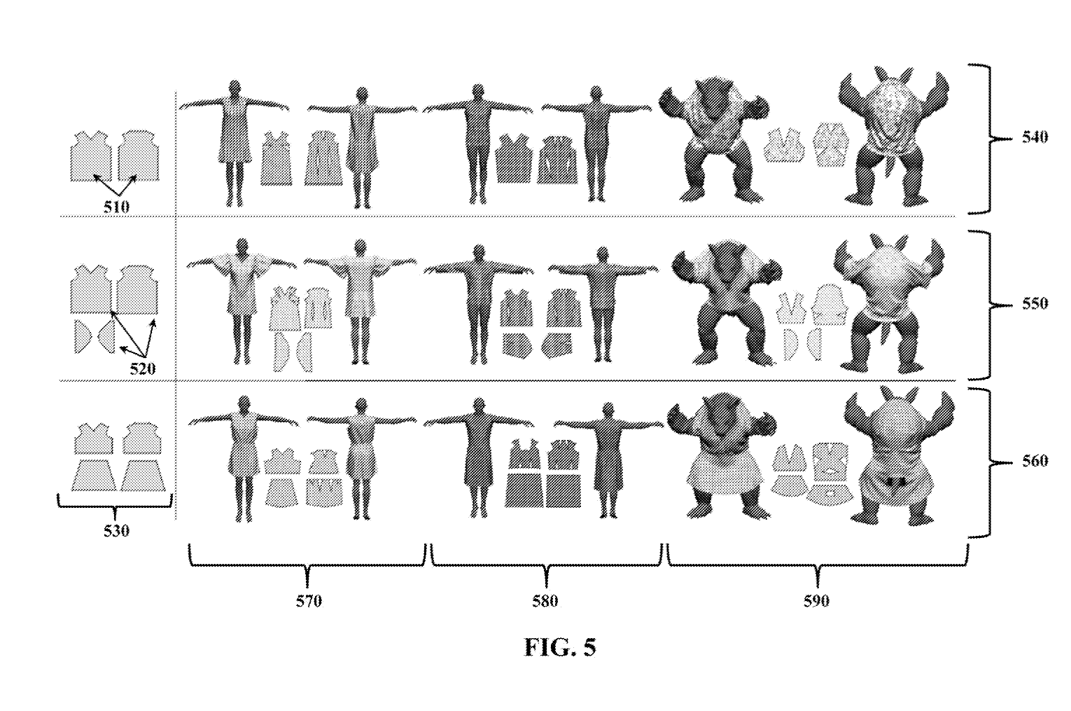

As shown in FIG. 5, the application can provide multiple slopers or templates 510, 520, and/or 530 for selection that allow a user to create a variety of garments. For example, rows 540, 550, and 560 illustrate that, in response to selecting one of the slopers 510, 520, or 530, the application allows the user to create a variety of dresses for a female body, a variety of shirts (e.g., with sleeves or without sleeves) and dresses for a male body, or a custom garment for an armadillo body. As shown, each of the designed garments started with a selected template and the user modified the selected template by changing boundary lines, adding darts, changing sewing or stitching (e.g., pleating, ruffling, etc.), and/or changing particular parameters to achieve the desired garment.

Additionally or alternatively, the interactive garment designing application can allow the user to create slopers, save slopers, and/or upload slopers. For example, the user can create and store a particular template that the user would like to use for future garment designs. In some embodiments, the application can retrieve from a user storage device and/or convert a file (e.g., a previous design) into a sloper for use by the interactive garment designing application.

As also shown in FIG. 5, the interactive garment designing application can provide the user with multiple dress forms or curved bodies. In some embodiments, the application can allow the user to select from multiple curved bodies for designing a garment. For example, FIG. 5 illustrates that the user can select between a female curved body, a male curved body, and a curved body in the form of an armadillo standing on its hind legs. In another example, the application can provide the user with an opportunity to modify parameters associated with the curved body (e.g., change the height, waist line, arm length, and/or other features of the curved body). In yet another example, the application can allow the user to upload a curved body for use by the application, such as, for example, a three-dimensional representation of an animated character.

It should be noted that the interactive garment designing application provides the user with a free-flowing design experience. For example, as a user makes detailed alterations to the two-dimensional patterns or the three-dimensional draped representation by inserting darts, modifying boundary curves, modifying sewing or stitching, etc., these detailed alterations ride over the sloper such that a user can revisit and/or edit the parameters of the sloper (e.g., sleeve length, upper length, etc.) without undoing or reversing the creating, style-defining alterations made by the user.

In some embodiments, the multiple interactive tools provided by the application can include a curve edit tool that allows the user to alter the shape and position of a pattern boundary, which can be defined by the control degrees of freedom of a spline. For example, as shown in FIG. 3, the application allows the user to modify the shape and position of the boundary on the sleeve of the garment. The application can store the positions of the curve edits relative to the sloper or template, thereby maintaining curve edits over adjustment to dimensions of the underlying sloper.

In some embodiments, the multiple interactive tools provided by the application can include a cutting tool that allows the user to split or divide a cloth pattern. For example, if the user using the cutting tool creates a sketch line that traverses across the cloth pattern, the application divides the pattern into two separate portions. In response, the application can update the three-dimensional draped representation to illustrate the cuts made to the cloth pattern. In another example, the user can use the cutting tool to cut away one or portions of a cloth pattern, which can be modified and/or sewn at a later time.

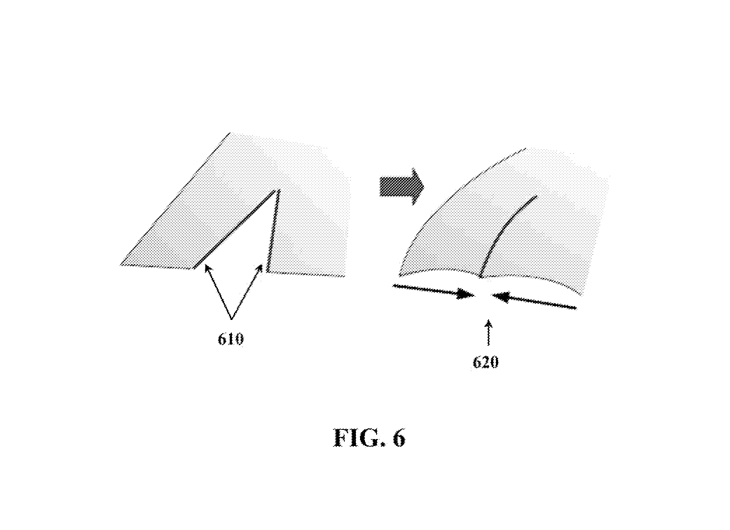

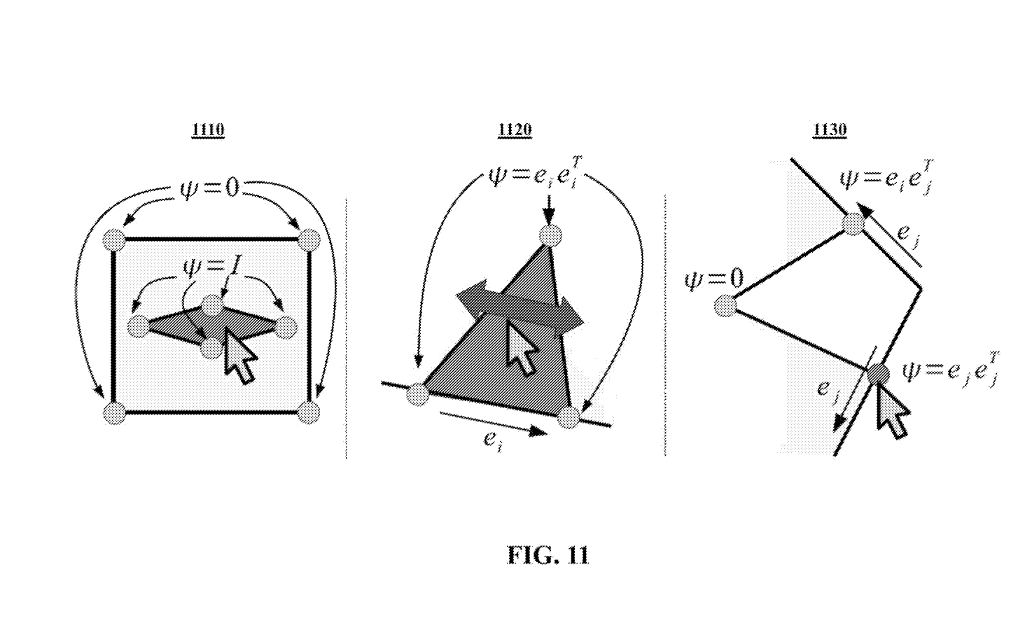

In some embodiments, the multiple interactive tools provided by the application can include a dart tool that allows the user to add and/or modify darts (e.g., triangular folds or excisions that induce intrinsic curvature or cone singularities). For example, as shown in FIGS. 4, 5, and 6, the application allows the user to insert a dart onto the pattern and, in response to adding the dart 610, the three-dimensional draped representation can be updated in real-time to show the addition of the dart. More particularly, the application can designate darts as first-order primitives such that each dart has dart-specific degrees of freedom to control position, shape, and/or size. For example, the user can apply the dart tool by drawing sketch lines 610. As shown in FIG. 6, if the user using the dart tool creates a line that intersects a boundary, the application can create a triangular dart that rides the boundary such that the user can later freely slide the dart along the boundary. Alternatively, as described herein, it should be noted that the user using the dart tool can also create one or more darts within the interior of the pattern (see, e.g., 1110 of FIG. 11). In response, simulation 620 illustrates that the application can automatically sew and stitch together both sides of the cut line.

In some embodiments, the multiple interactive tools provided by the application can include a sewing or pleating tool that allows the user to specify that two boundary segments be sewn together. For example, when using a mouse or other user input device, the user can select two boundary segments (e.g., either in the two-dimensional patterns or in the three-dimensional draped representation) to indicate that the two boundary segments be sewn together. It should be noted that, in some embodiments, the interactive garment designing application can automatically select the boundary orientations such that cloth inversion is inhibited. It should also be noted that, in some embodiments, when two boundary segments differ in length, the application can simulate the three-dimensional draped representation with a sequence of attractive doubled-back folds that gather a longer piece of fabric into a shorter length (a pleat).

In some embodiments, the multiple interactive tools provided by the application can include a symmetry tool that allows the user to mark boundary pieces as symmetric about an axis. In response, the application can enforce these indicated symmetries as the draped representation is being created and/or updated.

As described above, the interactive garment designing application can simultaneously and synchronously display a two-dimensional view having two-dimensional garment patterns and a three-dimensional view having a three-dimensional draped representation over a body. In accordance with some embodiments, the application can relate the two-dimensional configuration and the three-dimensional configuration by the following static equilibrium equation:

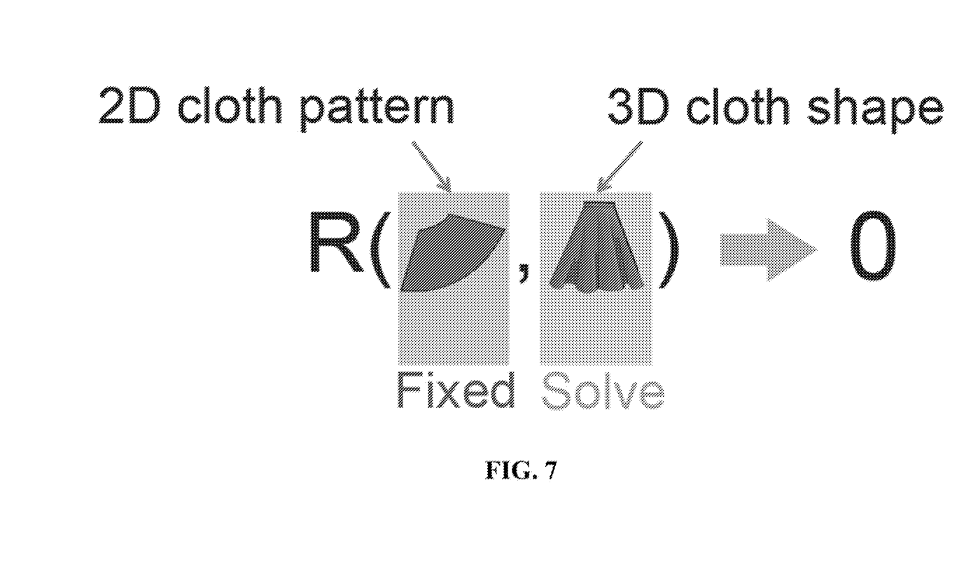

R(X,x)=F(X,x)−Q(X,x)=0

where Xε [symbol] ²ⁿ can be the undeformed configuration given by the two-dimensional perspective, xε [symbol] ³ⁿ can be the deformed configuration given by the three-dimensional perspective, and F, Qε [symbol] ³ⁿ can be the external (e.g., gravitational) and internal (e.g., elastic) forces, respectively. As shown in the above-mentioned equation, the two-dimensional perspective and the three-dimensional perspective are in correspondence when the residual R(X,x)ε [symbol] ³ⁿ vanishes or equals zero. An illustrative graphical representation of the static equilibrium equation is shown in FIG. 7.

It should be noted that, in some embodiments, the application can pre-compute or predetermine the solution for the above-mentioned equation to simulate the initial version of the three-dimensional draped representation. This precomputation can be performed a predetermined number of times (e.g., once) for a given garment design to, for example, reduce calculation time and resources.

In some embodiments, the interactive garment designing application can provide instantaneous feedback during editing by performing a design sensitivity analysis. The sensitivity analysis can predict the first-order response of the simulation of the three-dimensional draped representation with respect to a design parameter change. For example, suppose that the user alters the two-dimensional pattern configuration X to a nearby configuration X+ΔX (e.g., changing a boundary upon receiving a mouse drag operation from the user). By expanding the above-mentioned equation to first order, the application can represent the incremental update equation as follows:

(∇ₓR(X,x))ΔX(∇ₓR(X,x))Δx=0

where ∇ₓR is a stiffness matrix. That is, this equation provides the first order response of deformed node position x according to the change of undeformed position X. The linear map S can then be obtained that relates the change ΔX in the two-dimensional cloth pattern to the change Δx in the three-dimensional draped representation:

Δx=(∇ₓR)⁻¹(∇ₓR)ΔX=SΔX

where S is encoded by a 3n×2n design sensitivity matrix.

It should be noted that buckling, wrinkling, and static friction create a nonlinear relation between the two-dimensional patterns and the three-dimensional draped form. To account for this, the application can extend the sensitivity-based approach by accounting for nonlinearity via coupled simulation and progressive nonlinear modeling.

In some embodiments, during idle computing times (e.g., pauses in mouse movement), the application can integrate the system in time starting from the configuration produced by sensitivity-based increments.

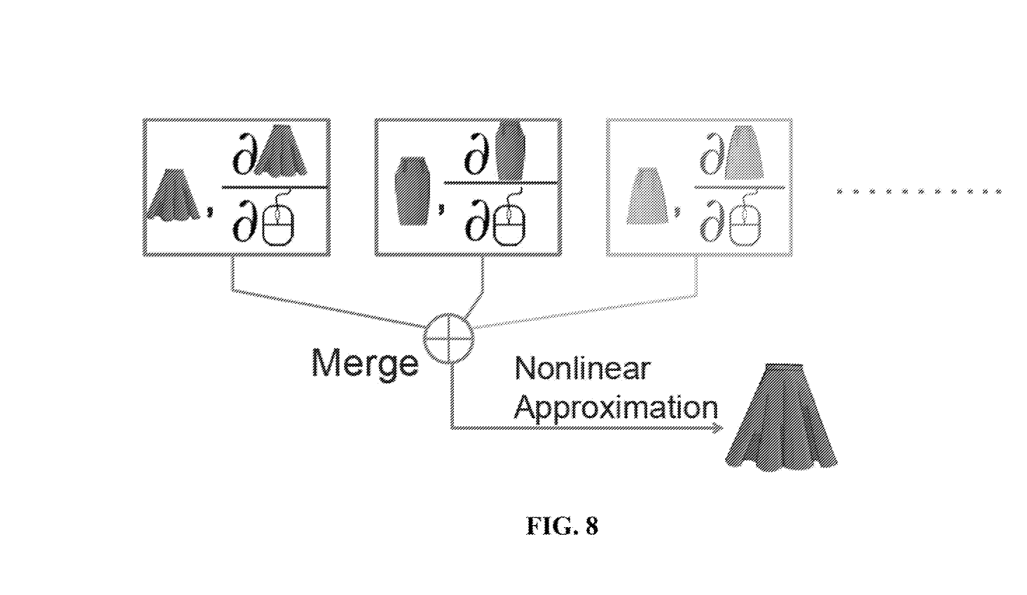

In some embodiments, the application can leverage pauses and the inclination to explore multiple design variants by a user. For example, the editing process for a garment may endure over a long duration (e.g., over thirty seconds), where the user pauses at various points as options are being considered. In response to detecting that a user hesitates or pauses when selecting between multiple design alternatives, the interactive garment designing application can cache one or more additional linearizations (sensitivity matrices or other sensitivity information), thus building up a nonlinear model of draped representations in the local design space. This progressive enrichment of the local model allocates computational resources proportionally to the interest in a given region of the design space. That is, the application can be most accurate near designs that interest the user. An illustration of the application accounting for nonlinearity by aggregating cached sensitivity matrices is shown, for example, in FIG. 8. As shown, the application determines a nonlinear approximation of the three-dimensional draped form by aggregating multiple cached sensitivity matrices.

In some embodiments, the additional linearizations or additional sensitivity information can be aggregated into the current simulation response using a generalized moving least squares (GMLS) approach. When the mouse pointer moves to position d=(d₁,d₂)^{T}, the application can draw upon at least two pieces of readily reusable data: the draped confirmation x⁰ε [symbol] ³ⁿ (the zeroth-order data) at the previous pointer position d⁰ε [symbol] ² and the sensitivities s₁^{m}=∂x/∂d₁,s₂^{m}=∂x/∂d₂ of the draped configurations xⁿε [symbol] ³ⁿ (the first-order data) at the cached previous configurations dⁿε [symbol] ² (m=1, . . . , M). The application can extend the derivations of GMLS interpolation to account for a combination of zeroth- and first-order samples. In particular, the interpolated configuration field is given by x(d)=a(d)p(d)ε [symbol] ³ⁿ, where aε [symbol] ^{3nx3} is a coefficient matrix applied to the monomial vector p=(1,d₁,d₂)^{T}. At a given pointer position d, the coefficients a are the minimizers of the lease-squares error metric:

$$J ( a ) = {\sum }_{m = 0}^{M} w ( d - {d}^{m} ) {‖ ap ( {d}^{m} ) - {x}^{m} ‖}^{2} + {\sum }_{m = 1}^{M} w ( d - {d}^{m} ) {\sum }_{j = 1}^{2} {‖ a \frac{\partial p}{\partial {d}_{j}} - {s}_{j}^{m} ‖}^{2}$$

where w is a suitably chosen weighting function. In some embodiments, w (d−dⁿ)=1/(∥dⁿ−d∥²+ε², where ε is a small constant guaranteeing finite weight (e.g., ε²=10⁻³). The above-mentioned J(a) equation can be minimized with respect to a, thereby obtaining:

$$x ( d ) = {\sum }_{m = 0}^{M} {x}^{m} {N}^{m} ( d ) + {\sum }_{m = 1}^{M} {\sum }_{j = 1}^{2} {s}_{j}^{m} {N}_{j}^{m} ( d ) , \\ {N}^{m} ( d ) = {p ( d )}^{T} {G ( d )}^{- 1} p ( {d}^{m} ) w ( d - {d}^{m} ) , \\ {N}_{j}^{m} ( d ) = {p ( d )}^{T} {G ( d )}^{- 1} \frac{\partial p}{\partial {d}_{j}} w ( d - {d}^{m} ) , \\ and$$

$$G ( d ) = {\sum }_{m = 0}^{M} w ( d - {d}^{m} ) p ( {d}^{m} ) {p ( {d}^{m} )}^{T} + {\sum }_{m = 1}^{M} w ( d - {d}^{m} ) {\sum }_{j = 1}^{2} \frac{\partial p}{\partial {d}_{j}} \frac{\partial {p}^{T}}{\partial {d}_{j}}$$

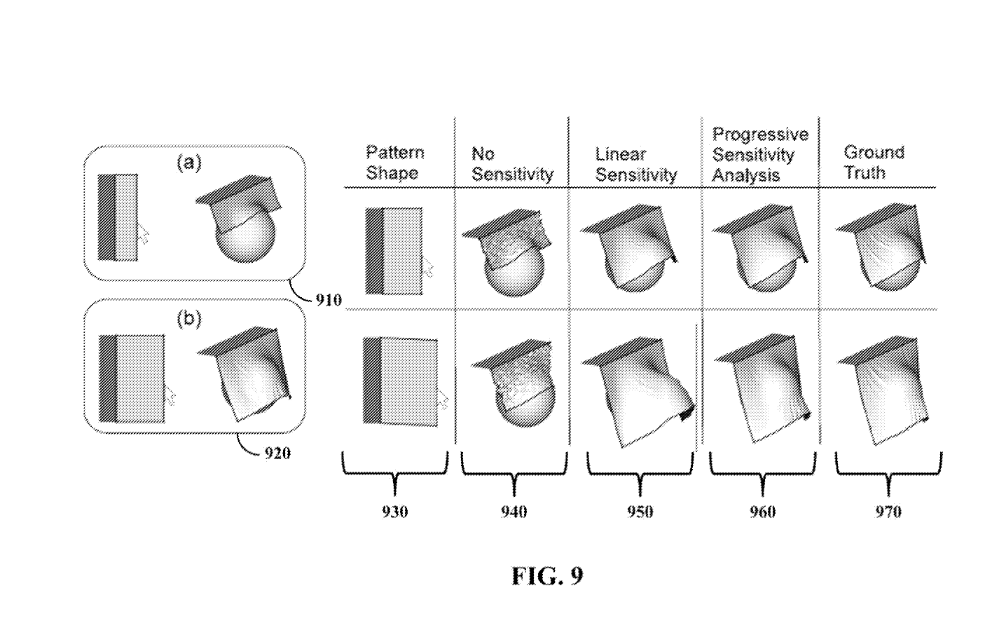

FIG. 9 shows an illustrative comparison of various sensitivity approaches and, in particular, the result from progressive sensitivity analysis with a generalized moving least squares approach in accordance with some embodiments of the disclosed subject matter. As shown in FIG. 9, the comparison begins with a hanging cloth partly draped over a spherical body. It should be noted that, as shown in the figures described herein, any suitable body can be used (e.g., a curved body in the form of a man, a curved body in the form of a woman, a curved body in the form of an animated character, a curved body in the form of furniture, etc.). Windows 910 and 920 of FIG. 9 provide the cached solutions employed by sensitivity. The application then receives an editing instruction or user manipulation in which the length of the cloth is modified (e.g., lengthened) in the undeformed two-dimensional pattern (as shown in column 930). Columns 940, 950, and 960 show different sensitivity approaches—e.g., an editing operation using only a dynamic, kinetically-damped simulation 940 (e.g., no sensitivity analysis), an editing operation augmented with linear sensitivity analysis 950, and an editing operation augmented with progressive sensitivity analysis using a generalized moving least squares (GMLS) approach 960, respectively. It should be noted that the dynamic simulation 940 lags behind the edit instructed by the user and provides an unrealistic draped form (as shown in column 940). It should also be noted that, while linear sensitivity can eliminate these artifacts (as shown in 950), the overall draped shape is not modeled well. Lastly, the progressive sensitivity analysis with the GMLS approach shown in 960 exhibits stable results that better correspond with the ground truth image shown in 970.

In some embodiments, the interactive garment designing application uses sensitivity information (e.g., the sensitivity matrices) to interpret editing instructions or operations applied directly to the three-dimensional draped representation. Referring back to FIG. 2, consider editing a sloper parameter gε [symbol] , such as sleeve length or lower waist length. When the pointer is depressed with a mouse click (or any other suitable gesture) over the three-dimensional draped representation, the application can identify the corresponding material point (u, v)ε [symbol] ² on the two-dimensional pattern and can calculate a sensitivity vector s=∇_{g}x(u,v)ε [symbol] ³ (the first-order three-dimensional motion of the cloth at the picked point with respect to the sloper parameter g).

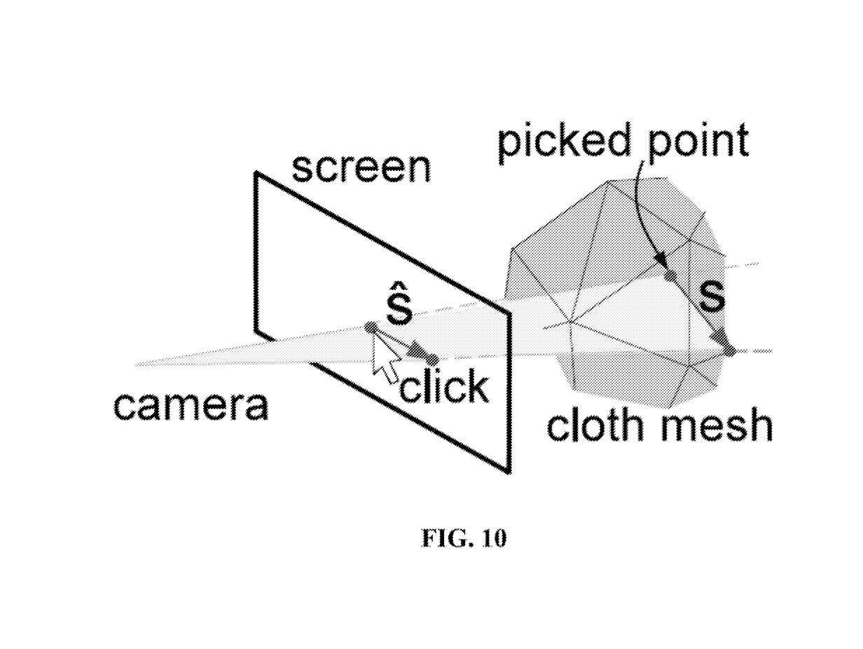

It should be noted that, in some embodiments, the 3-vector s is projected to the screen space vector ŝε [symbol] ², which gives the first-order motion of the picked screen point with respect to the sloper parameter g. An illustration of this projection is shown in FIG. 10. As the user using a user input device drags the pointer from dε [symbol] ² to d+Δdε [symbol] ², the application can update the sloper parameter by the following incremental relation:

Δg=ŝ·Δd/∥ŝ∥²

From the above-mentioned equation, it should be noted that, when ∥ŝ∥ is small, the selected screen point is generally insensitive to the sloper parameter g. For example, the position of a shirt collar can be independent of sleeve length. Accordingly, in some embodiments, the application can neglect the drag when ∥ŝ∥ is small.

Accordingly, the interactive garment designing application can provide sensitivity analysis for interactive exploration of nearby designs and provide adaptive enrichment of the sensitivity information using a general moving least squares approach to leverage the user's natural pauses and inclination to explore multiple design variants.

In some embodiments, the interactive garment designing application can include the selection of one or more cloth models. For example, in one suitable embodiment, the application can use triangle meshes with multiple models that treat bending and stretching models separately. In a more particular example, for the bending model, the application can use an isometric bending model, which has a constant energy Hessian, thereby eliminating the cost of the force Jacobian computation for implicit time integration, providing a simple matrix-vector multiplication for bending force computation (which can be ported to a graphics processing unit), and ensuring that the Hessian remains positive semi-definite for configurations and thereby stabilizing numerics. These and other features of isometric bending models are further described, for example, in Bergou et al., “A Quadratic Bending Model for Inextensible Surfaces,” in Fourth Eurographics Symposium on Geometry Processing, pages 227-230, which is incorporated by reference herein in its entirety.

In another more particular example, for the stretching model, the application can include a stabilized St. Venant-Kirchhoff (StVK) constant strain triangle (CST) model. When the element is in a compressed configuration, the Jacobian entries can be adjusted to eliminate negative eigenvalues. This stabilization can affect the trajectory towards the draped configuration, but does not alter the set of solutions of the static equilibrium equations. Accordingly, this stabilization assures stability without affecting the draped shape.

In some embodiments, the interactive garment designing application can provide mesh updates that are linear in pattern element alteration and/or remeshing features. More particularly, as described herein, for two-dimensional pattern manipulation, the application can use a positive mean value coordinates approach with Delaunay smoothing. For example, when the user uses the pointer to drag two-dimensional pattern elements (e.g., boundary vertices, darts, or boundary spline tangents), the application updates the positions of the internal vertices, thereby maintaining uniform, well-shaped elements throughout the material domain.

For each kind of pattern element, the application can define how pointer motion affects the control vertices of a two-dimensional pattern element—e.g., for a boundary dart, a drag centered inside the dart moves the three control vertices identically, whereas a drag of the dart's interior control vertex leaves the boundary stationary. Let Ψᵢ be the 2×2 tensor relating pointer movement Δd to the movement Ψᵢ Δd of the ith control vertex. As shown in 1110 of FIG. 11, for the translation of an interior (diamond) dart, Ψ=1 or Ψ=0 in which the control vertex follows the pointer or remains stationary, respectively. As shown in 1120, for the translation of a boundary dart, Ψ=eᵢeᵢ^{T} in which the control vertex shadows the pointer movement only in the direction eᵢ. As shown in 1130, for the adjustment of a boundary dart opening, Ψ=eᵢeⱼ^{T} in which the control vertex moves along direction eᵢ when the pointer moves along direction eⱼ.

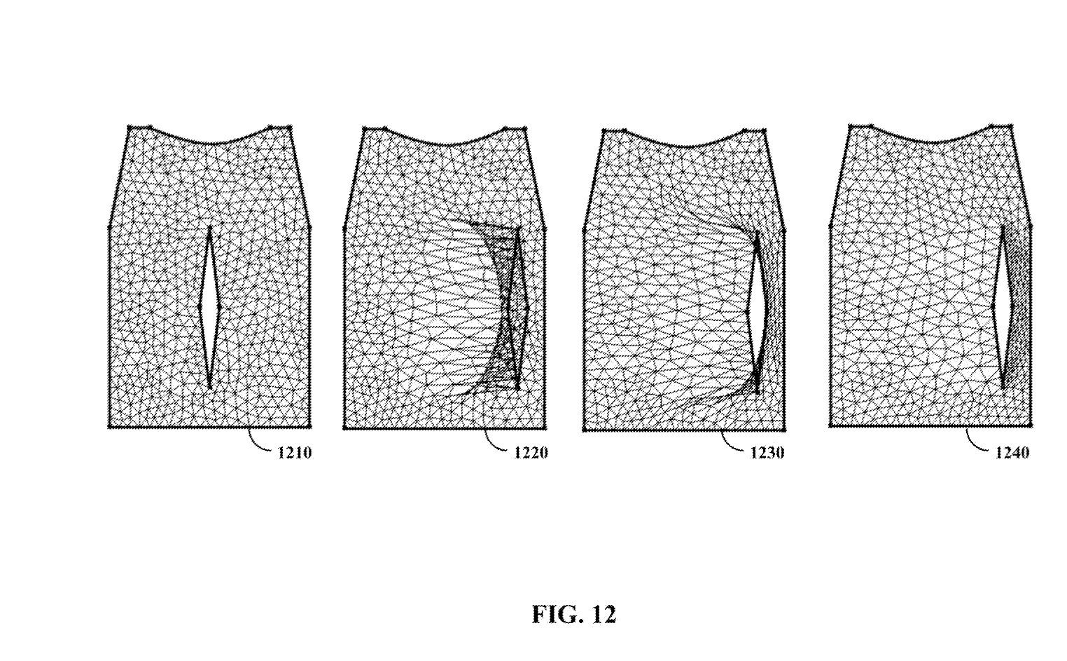

By defining the tensor field Ψ at the control vertices, the application can interpolate the motion in the remainder of the domain. Since Ψ is known at boundary control vertices, the application can perform a linear interpolation along the boundary and use positive mean value coordinates (PMVC) to efficiently determine the tensor field Ψ throughout the domain. PMVC builds on mean value coordinates by incorporating a notion of visibility, which can enhance the coordinate's interpolation capability in the non-convex higher genus shapes typical of two-dimensional design patterns. To illustrate this, FIG. 12 shows an illustrative comparison of different pattern manipulation approaches with an undeformed mesh in accordance with some embodiments. As shown, FIG. 12 includes an undeformed mesh 1210, a mesh manipulation with mean value coordinates in mesh 1220, and a mesh manipulation with positive mean value coordinates in mesh 1230. As shown, when the application uses the positive mean value coordinates approach shown in mesh 1230, a homogenous deformation can be generated that avoids distortions and/or inversions.

It should be noted that, with the tensor field Ψ=[Ψhd 1, Ψ₂, . . . ]^{T}, the application can calculate sensitivity by mapping pointer movement to two-dimensional mesh movement ΔX=ΨΔd.

In some embodiments, a Delaunay smoothing scheme can be applied to improve the mesh (while maintaining linearity). More particularly, the application can use a Delaunay smoothing scheme to update mesh connectivity retaining nodal positions. It should be noted that displacement and sensitivity can be stored at vertices and need not be recomputed, thereby making this an inexpensive approach for improving the mesh. Referring back to FIG. 12, mesh 1240 provides an illustrative example of the application using a positive mean value coordinates approach with Delaunay smoothing. This allows for linear interpolation over a domain, while enabling a substantially satisfying interpolation in nonconvex higher-genus domains.

Alternatively, if a measurement of mesh quality (e.g., determining the ratio of diameter of incircle against the maximum edge length) shows that the mesh quality continues to be poor or insignificantly improved, the application can rebuild the mesh and interpolate the simulation state to the rebuilt mesh using barycentric coordinates.

As described previously, when generating the initial draped representation, the interactive garment designing application can solve the above-mentioned static equilibrium equation. It should be noted that the solution for the static equilibrium equation can also be calculated when new two-dimensional pattern elements are added during the design process.

In one suitable embodiment, the static equilibrium can be determined by employing a kinetic damping approach, which integrates the undamped equations of motion while monitoring total kinetic energy at each time step. When the kinetic energy reaches a local maximum (e.g., a condition that can be evaluated by considering three consecutive time steps), the kinetic damping approach zeros the velocity (the kinetic energy).

The application can apply the kinetic damping approach to a semi-implicit time integration scheme. Since the coefficient matrix of the dynamic simulation and sensitivity analysis are both positive-definite, the system can be solved using conjugate gradients preconditioned with ILU(0). While the bending model has a constant Hessian, the StVK. CST membrane model does not, and the application numerically factorizes the matrix at every time step.

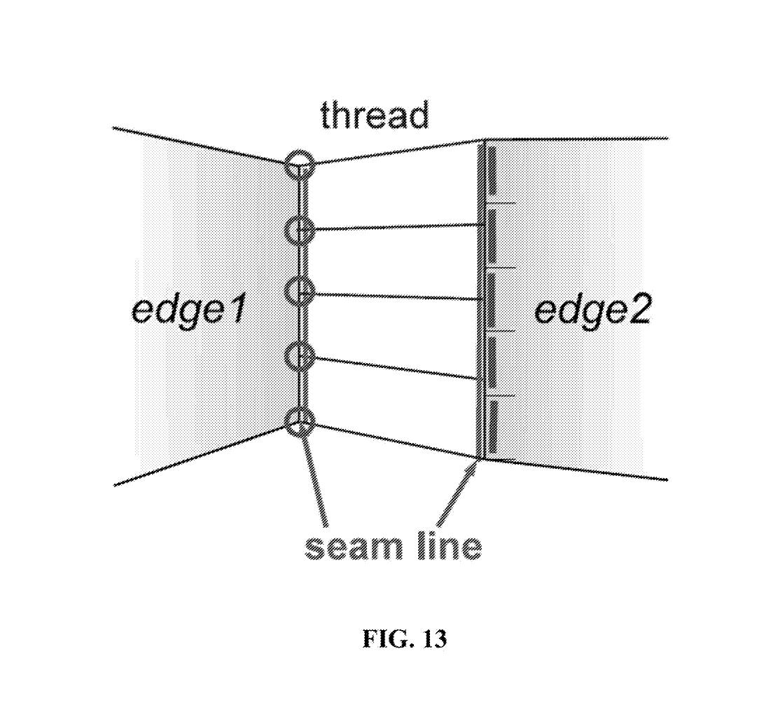

It should be noted that the performance of ILU(0) preconditioning can be substantially influenced by choices in the treatment of seams. In accordance with various embodiments of the disclosed subject matter, the interactive garment designing application can sew boundaries of corresponding panels using Hookean springs. Generally speaking, the boundaries do not correspond in length (a feature in dressmaking used to effect pleats and ruffles) or in connectivity. Accordingly, the application connects the emitting vertices of one panel with springs anchored at receiving boundary edges of the other panel. This is illustrated, for example, in FIG. 13. To avoid gaps at the seams, the seam springs can be substantially stiffer than textile tensile stiffness. The consequent linear system has stiff and weak components, thus the success of ILU(0) preconditioning can depend on the permutation of matrix entries. That is, ILU(0) favors permutations where large entries appear earlier and small entries appear later. Entries associated to emitting vertices dominate entries of receiving vertices, which in turn dominate other vertices.

It should also be noted that the application can estimate the penalty stiffness to obtain a sufficient seal at the seams. Penalty-based seams can maintain the positive-definiteness of the system and, since the set of dominating matrix entries is given by a tallying of seam vertices (which generally remains constant except during exceptional stitching events), the permutation for ILU(0) is of insignificant implementation and computational cost.

In some embodiments, the interactive garment designing application includes one or more contact models to describe contact between the garment and the body. The one or more contact models can, for example, allow the application to provide stable draping and frictional wrinkling. More particularly, the contact model can describe contact and friction between the cloth garment and the body. Similar to the seams described above, the application can enforce contact constraints at mesh nodes using penalty springs. For describing contact, springs can be placed at collision sites detected by an adaptive signed distance field. For describing friction, a moving anchor spring approach can be used that enables both static and dynamic friction modes, where contacting nodes are connected by springs to seeded anchor vertices placed on the contacting surface. The application can then update or release anchor positions with respect to nodal movement.

It should be noted that the application using the one or more contact models may not consider self-contact between portions of the same garment.

In some embodiments, when allowing a user to edit and/or refine a garment, the interactive garment designing application can use a progressive refinement approach for displaying the three-dimensional draped representation and, in particular, edits and design selections made to the draped representation. More particularly, in response to receiving input from the user (e.g., alterations to the garment), the application can initially solve and generate the draped representation using a coarsened mesh. If convergence is reached at the coarse-level prior to the initiation of further design edits or alterations, the application can warm start the generation of a fine mesh draped representation with the draped representation using the coarsened mesh. It should be noted that fine-level nodes can be updated progressively using barycentric coordinates from the coarsened information and, upon determination at a later time and when not interrupted (e.g., by new design edits), using direct update from the fine-level solve.

In some embodiments, the application can designate which draped representation to display to the user. For example, the application can designate to only display fine mesh representations to the user. In another example, the application can designate to display the latest determined draped representation—e.g., a coarsened mesh representation followed by a fine mesh representation. Alternatively, the application can provide the user with an option for setting which draped representations are to be displayed in display screen (see, e.g., FIG. 1).

As described above, a user of the interactive garment designing application can modify a two-dimensional flat pattern (e.g., using click, drag, and/or release mouse manipulations) and, in response to the mouse manipulations, the interactive garment designing application can perform various determinations (e.g., sensitivity analysis, tensor mesh manipulation, etc.) and display the resulting effects on the three-dimensional form, thereby providing instantaneous feedback during editing. Similarly, the user can modify the three-dimensional draped representation and, in response, the application can perform various determinations and display the resulting effects on the two-dimensional flat pattern.

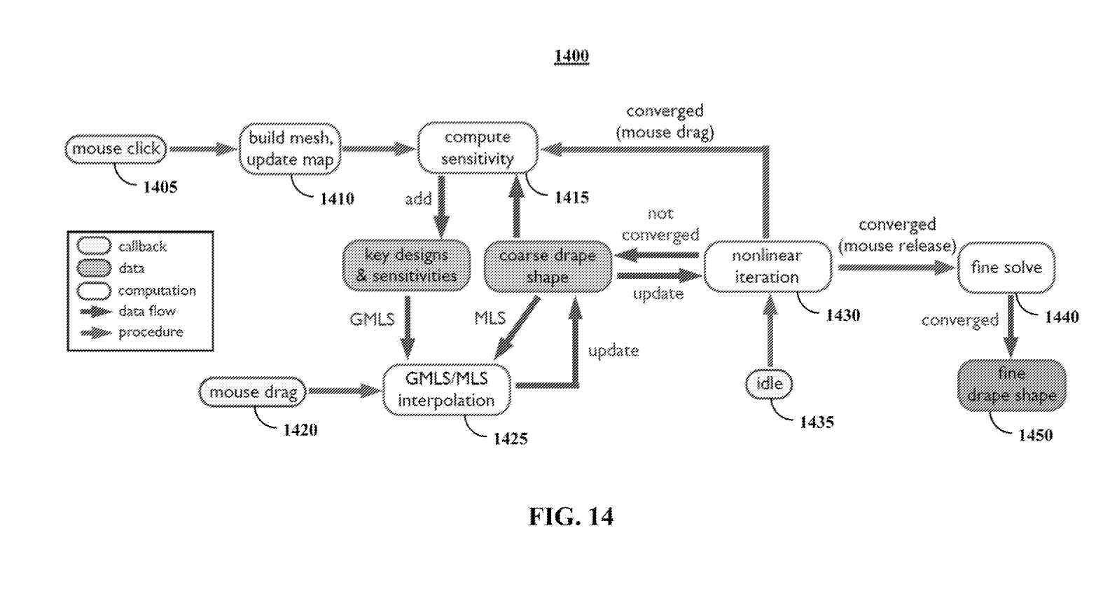

FIG. 14 shows an illustrative example of a process for synchronizing the two-dimensional patterns and the three-dimensional draped representation in accordance with some embodiments of the disclosed subject matter. It should be noted that, in the process 1400 of FIG. 14 and any other process or method described herein, some steps can be added, some steps can be omitted, the order of the steps can be re-arranged, and/or some steps can be performed simultaneously (e.g., performing parallel calculations using multiple threads).

As shown, process 1400 can begin with receiving a mouse click (or any other suitable gesture) at 1405. In response to receiving the mouse click, the application can build the initial mesh and determine the mapping between mesh updates and XY mouse movements at 1410. At 1415, the application can then perform a sensitivity analysis to determine the corresponding bi-modal linear response at the clicked mouse position with respect to these maps. For example, as described previously, when editing a sloper parameter by depressing a mouse pointer over the three-dimensional representation, the application can identify the corresponding material point on the cloth pattern and calculates the sensitivity vector (the first-order three-dimensional motion of the cloth at the picked point with respect to the sloper parameter).

At 1420, the application can receive a mouse drag operation (or any other suitable gesture, such as a maintaining contact with a finger or a stylus). While edits are being performed with the mouse button held down, the application can provide an instantaneous linear response at 1425. As the editing process continues, progressive nonlinear modeling with a generalized moving least squares (GMLS) approach can enrich the local model and the corresponding response at 1430. For example, the application can calculate an interpolation that draws upon both sensitivity data (first-order data) at cached previous configurations and position data (zeroth-order data) at the previous pointer position.

In addition, when the application detects an idle period of time at 1435, the application can perform sensitivity-based positional updates and evaluate and cache additional linearizations (sensitivity matrices) at 1415, thus building up a nonlinear model of drapes in the local design space. Using progressive nonlinear modeling with a GMLS approach, these additional linearizations can be aggregated or updated into the initial simulation response.

At 1440, when the mouse button is released, the current sensitivity information can be used to warm start the next time integration cycle and a fine mesh draped representation can be generated and display to the user at 1450.

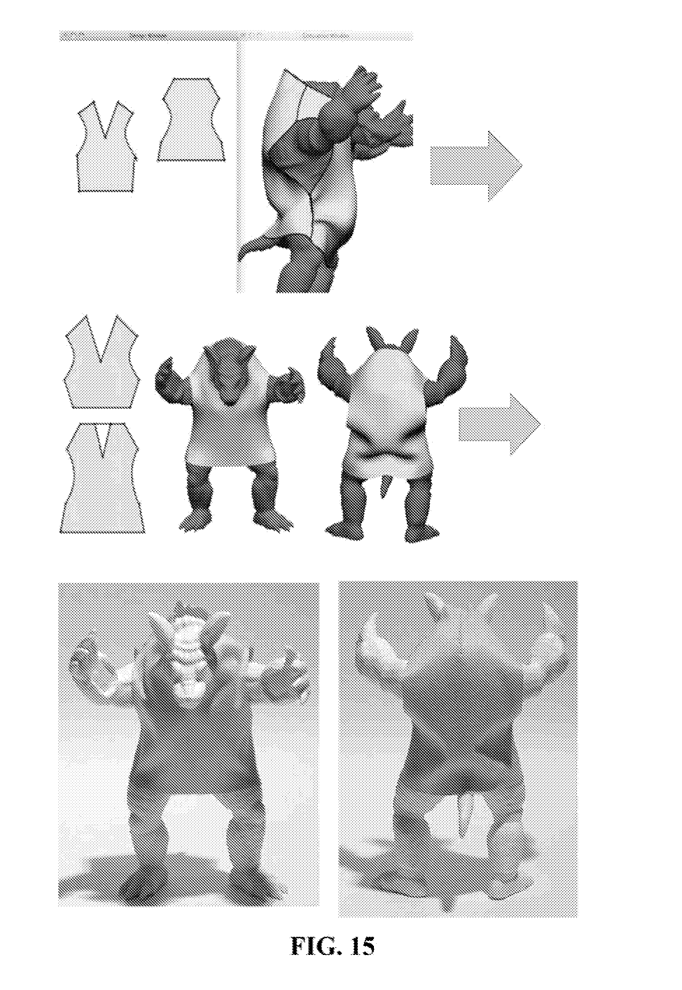

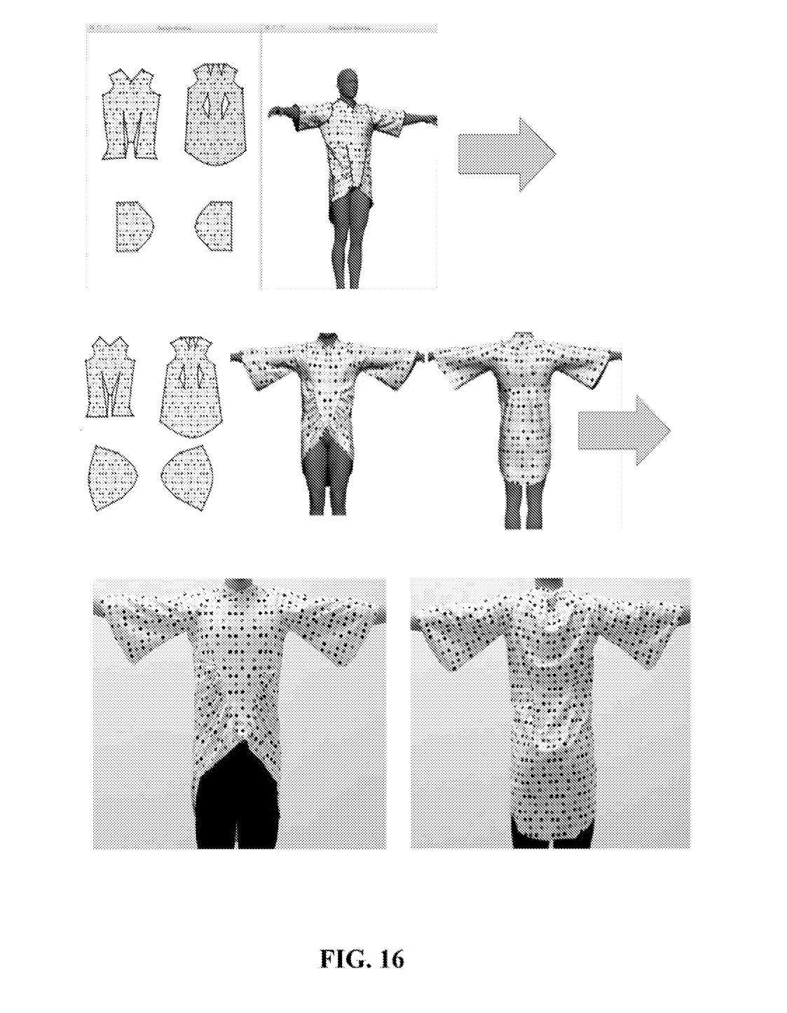

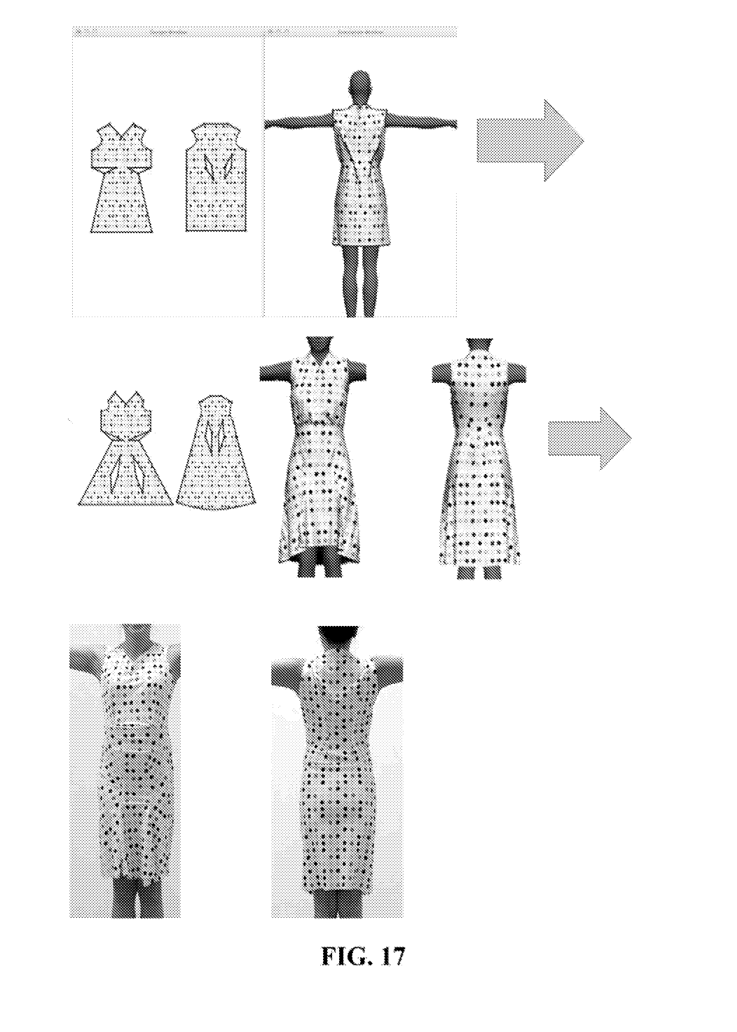

The interactive garment designing application can provide a user with bidirectional design and editing capabilities for the generation of two-dimensional patterns and a simulated three-dimensional draped representation. As shown in FIGS. 15-17, each figure illustrates the simultaneous display of a two-dimensional pattern and a simulated three-dimensional draped representation. The application can provide the user with a sloper or template for designing a garment. The application also provides the user with bidirectional editing tools for modifying the two-dimensional pattern and/or the three-dimensional draped representation to achieve a desired garment. Based on the preview provided by the simulated three-dimensional draped form, the two-dimensional patterns are then cut and stitched together to manufacture an actual garment (which is shown being worn by an armadillo figurine in FIG. 15, a male model in FIG. 16, and a female model in FIG. 17).

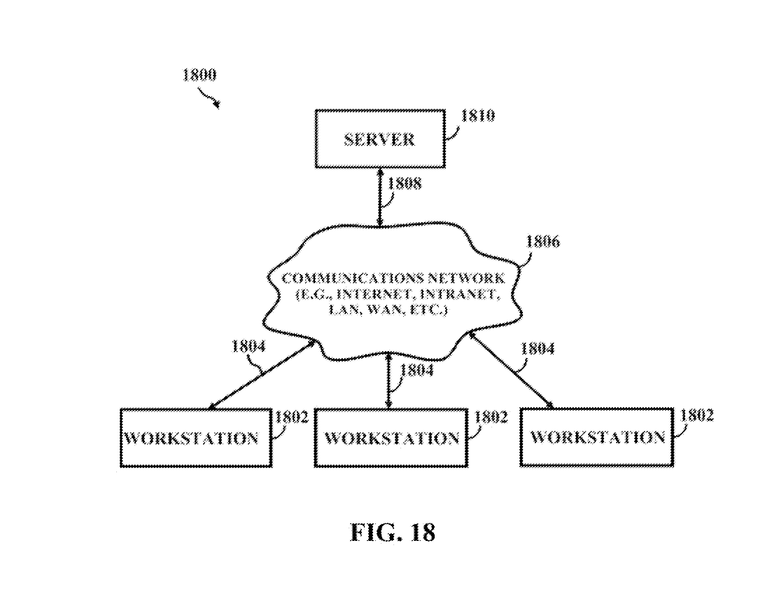

FIG. 18 is a generalized schematic diagram of a system 1800 on which the interactive garment designing application can be implemented in accordance with some embodiments of the disclosed subject matter. As illustrated, system 1800 can include one or more user computers 1802. User computers 1802 can be local to each other or remote from each other. User computers 1802 are connected by one or more communications links 1804 to a communications network 1806 that is linked via a communications link 1808 to a server 1810.

System 1800 can include one or more servers 1810. Server 1810 can be any suitable server for providing access to the application, such as a processor, a computer, a data processing device, or a combination of such devices. For example, the application can be distributed into multiple backend components and multiple frontend components or interfaces. In a more particular example, backend components, such as data collection and data distribution can be performed on one or more servers 1810. Similarly, the graphical user interfaces displayed by the application, such as a data interface and an advertising network interface, can be distributed by one or more servers 1810 to user computer 1802.

More particularly, for example, each of the client 1802 and server 1810 can be any of a general purpose device such as a computer or a special purpose device such as a client, a server, etc. Any of these general or special purpose devices can include any suitable components such as a processor (which can be a microprocessor, digital signal processor, a controller, etc.), memory, communication interfaces, display controllers, input devices, etc. For example, client 1302 can be implemented as a personal computer, a tablet computing device, a personal data assistant (PDA), a portable email device, a multimedia terminal, a mobile telephone, a gaming device, a set-top box, a television, etc.

In some embodiments, any suitable computer readable media can be used for storing instructions for performing the processes described herein, can be used as a content distribution that stores content and a payload, etc. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Referring back to FIG. 18, communications network 1806 may be any suitable computer network including the Internet, an intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), or any combination of any of such networks. Communications links 1804 and 1808 may be any communications links suitable for communicating data between user computers 1802 and server 1810, such as network links, dial-up links, wireless links, hard-wired links, any other suitable communications links, or a combination of such links. User computers 1802 enable a user to access features of the application. User computers 1802 may be personal computers, laptop computers, mainframe computers, dumb terminals, data displays, Internet browsers, personal digital assistants (“PDAs”), two-way pagers, wireless terminals, portable telephones, any other suitable access device, or any combination of such devices. User computers 1802 and server 1810 may be located at any suitable location. In one embodiment, user computers 1802 and server 1810 may be located within an organization. Alternatively, user computers 1802 and server 1810 may be distributed between multiple organizations.

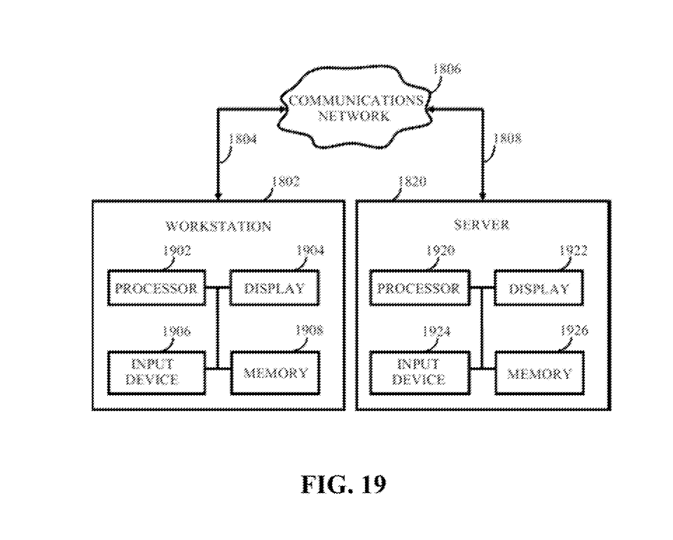

Referring back to FIG. 18, the server and one of the user computers depicted in FIG. 18 are illustrated in more detail in FIG. 19. Referring to FIG. 19, user computer 1802 may include processor 1902, display 1904, input device 1906, and memory 1908, which may be interconnected. In a preferred embodiment, memory 1908 contains a storage device for storing a computer program for controlling processor 1902.

Processor 1902 uses the computer program to present on display 1904 the application and the data received through communications link 1804 and commands and values transmitted by a user of user computer 1802. It should also be noted that data received through communications link 1804 or any other communications links may be received from any suitable source. Input device 1906 may be a computer keyboard, a mouse, a cursor-controller, dial, switchbank, lever, or any other suitable input device as would be used by a designer of input systems or process control systems. Alternatively, input device 1906 may be a finger or stylus used on a touch screen display 1904.

Server 1810 may include processor 1920, display 1922, input device 1924, and memory 1926, which may be interconnected. In a preferred embodiment, memory 1926 contains a storage device for storing data received through communications link 1808 or through other links, and also receives commands and values transmitted by one or more users. The storage device further contains a server program for controlling processor 1920.

In some embodiments, the application may include an application program interface (not shown), or alternatively, the application may be resident in the memory of user computer 1802 or server 1810. In another suitable embodiment, the only distribution to user computer 1802 may be a graphical user interface (“GUI”) which allows a user to interact with the application resident at, for example, server 1810.

In one particular embodiment, the application may include client-side software, hardware, or both. For example, the application may encompass one or more Web-pages or Web-page portions (e.g., via any suitable encoding, such as HyperText Markup Language (“HTML”), Dynamic HyperText Markup Language (“DHTML”), Extensible Markup Language (“XML”), JavaServer Pages (“JSP”), Active Server Pages (“ASP”), Cold Fusion, or any other suitable approaches).

Although the application is described herein as being implemented on a user computer and/or server, this is only illustrative. The application may be implemented on any suitable platform (e.g., a personal computer (“PC”), a mainframe computer, a dumb terminal, a data display, a two-way pager, a wireless terminal, a portable telephone, a portable computer, a palmtop computer, an H/PC, an automobile PC, a laptop computer, a cellular phone, a personal digital assistant (“PDA”), a combined cellular phone and PDA, etc.) to provide such features.

Accordingly, methods, systems, and media for interactive garment modeling and editing are provided.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for designing garments, the method comprising:
receiving a pattern template comprising a plurality of two-dimensional pattern elements for designing a garment;
simultaneously displaying the plurality of two-dimensional pattern elements and a three-dimensional draped model, wherein the three-dimensional draped model is a simulated representation of the two-dimensional pattern elements stitched together;
receiving an alteration command to at least a portion of one of: a pattern element of the plurality of two-dimensional pattern elements and the three-dimensional draped model;
in response to receiving the alteration command, determining sensitivity information for predicting changes to the plurality of two-dimensional pattern elements and the three-dimensional draped model; and
simultaneously updating the plurality of two-dimensional pattern elements and the three-dimensional draped model based at least in part on the determined sensitivity information.

2. The method of claim 1, further comprising assembling the plurality of updated two-dimensional pattern elements to create the garment.

3. The method of claim 1, wherein the three-dimensional draped model is synchronously updated in response to receiving the alteration command on one of the plurality of two-dimensional pattern elements.

4. The method of claim 3, wherein the sensitivity information comprises a prediction of drape shape change to the three-dimensional draped model based on the alteration command to one of the plurality of two-dimensional pattern elements.

5. The method of claim 4, wherein the three-dimensional draped model is updated with the predicted drape shape change.

6. The method of claim 1, wherein at least one of the plurality of two-dimensional pattern elements is synchronously updated in response to receiving the alteration command on the three-dimensional draped model.

7. The method of claim 6, further comprising:
detecting a selected point on the three-dimensional draped model associated with the alteration command;
identifying a corresponding point on the pattern of the plurality of two-dimensional pattern elements; and
determining the sensitivity information relative to the corresponding point.

8. The method of claim 1, wherein a plurality of parameters are associated with the pattern template.

9. The method of claim 8, wherein the alteration command includes one or more of: adjusting one of the plurality of parameters, cutting a pattern, altering a shape of a pattern boundary, altering a position of a pattern boundary, inserting a dart, modifying a dart, sewing two boundary segments, and forming a pleat.

10. The method of claim 1, wherein the alteration command is provided by a user input device.

11. The method of claim 1, wherein the sensitivity information comprises determining a sensitivity matrix based on a movement from a user input device.

12. The method of claim 12, further comprising:
detecting a pause in movement from a user input device;
in response to detecting the pause, determining and storing additional sensitivity matrices; and
aggregating the additional sensitivity matrices with the sensitivity matrix.

13. The method of claim 12, wherein the three-dimensional draped model is updated based on the sensitivity matrix, the additional sensitivity matrices, and pointer position information from a user input device.

14. The method of claim 12, further comprising using a generalized moving least squares interpolation operation to aggregate the additional sensitivity matrices with the sensitivity matrix.

15. The method of claim 1, further comprising providing a plurality of cloth models associated with the three-dimensional draped model, wherein the plurality of cloth models include at least one bending model and at least one stretching model.

16. The method of claim 15, wherein the at least one bending model is an isometric bending model and the at least one stretching model is a stabilized St. Venant-Kirchhoff constant strain triangle model.

17. A system for designing garments, the system comprising:
a processor that is configured to:
receive a pattern template comprising a plurality of two-dimensional pattern elements for designing a garment;
simultaneously display the plurality of two-dimensional pattern elements and a three-dimensional draped model, wherein the three-dimensional draped model is a simulated representation of the two-dimensional pattern elements stitched together;
receive an alteration command to at least a portion of one of: a pattern element of the plurality of two-dimensional pattern elements and the three-dimensional draped model;
in response to receiving the alteration command, determine sensitivity information for predicting changes to the plurality of two-dimensional pattern elements and the three-dimensional draped model; and
simultaneously update the plurality of two-dimensional pattern elements and the three-dimensional draped model based at least in part on the determined sensitivity information.

18. A non-transitory computer-readable medium containing computer-executable instructions that, when executed by a processor, cause the processor to perform a method for designing garments, the method comprising:
receiving a pattern template comprising a plurality of two-dimensional pattern elements for designing a garment;
simultaneously displaying the plurality of two-dimensional pattern elements and a three-dimensional draped model, wherein the three-dimensional draped model is a simulated representation of the two-dimensional pattern elements stitched together;
receiving an alteration command to at least a portion of one of: a pattern element of the plurality of two-dimensional pattern elements and the three-dimensional draped model;
in response to receiving the alteration command, determining sensitivity information for predicting changes to the plurality of two-dimensional pattern elements and the three-dimensional draped model; and
simultaneously updating the plurality of two-dimensional pattern elements and the three-dimensional draped model based at least in part on the determined sensitivity information.
